(19) United States
(12) Patent Application Publication
(10) Pub. No.: US 2006/0032819 A1
(43) Pub. Date: Feb. 16, 2006

(54) Water treatment device for electrolyzing, magnetizing, and re-resonating water

(76) Inventor: Peter Nunn, Victoria (CA)

Correspondence Address: Madson & Metcalf, 15 West South Temple, Suite 900, Salt Lake City, UT, 84101, US

(21) Appl. No.: 10/521,690

(22) PCT Filed: Jul. 17, 2003
(86) PCT No.: PCT/CA03/01032

§ 371 Date: Jan. 18, 2005

Related U.S. Application Data
(60) Provisional application No. 60/396,081, filed on Jul. 17, 2002.

(51) Int. Cl. C02F 1/48

(52) U.S. Cl. 210/695

(57) ABSTRACT

A method and device for producing electrolyzed, magnetized, and re-resonated water are disclosed. The water treatment device includes an electrolytic chamber separated into an anode chamber and a cathode chamber by a semi-permeable membrane. The cathode chamber contains a vortex cathode and a magnet placed above the vortex cathode. Electrolyzed, magnetized, and re-resonated water can be produced by filling the water treatment device with an electrolytic solute and running current through the device to produce alkaline water at the cathode, which is then re-resonated and magnetized by the action of the vortex cathode and magnet.

### CROSS REFERENCE TO RELATED APPLICATION

This application claims the benefit of U.S. provisional application No. 60/396,081 filed 17 Jul. 2002.

### TECHNICAL FIELD

This invention relates to water treatment devices, and in particular, to a method and device for electrolyzing, magnetizing, and re-resonating water in a batch system.

### BACKGROUND

Water properties can be measured using indicators such as pH, redox potential, and resistivity. Water with high pH (i.e. alkaline water), high oxidation-reduction potential, and high resistivity is believed to have health effects when consumed. Therefore, there is a demand for devices which produce water with these qualities.

One method of treating water to impart desired properties to the water is to electrolyze it. Electrolysis of water produces oxygen and hydrogen gas through oxidation-reduction reactions, and acidic and alkaline water are by-products of these reactions. Various types of electrolytic water treatment devices are available. Some electrolytic water treatment devices are designed as flow-through apparatuses, whereby water is electrolytically treated as it flows through the device. See for example U.S. Pat. No. 5,615,764 (Satoh). Other devices are batch treatment devices, which are designed to treat a fixed volume of water. See for example U.S. Pat. No. 5,435,894 (Hayakawa).

One problem with flow-through electrolytic water treatment devices is that it is difficult to expose flowing water to a consistent electrical charge. The water must flow through multiple electrolysis chambers in order to produce a consistent concentration of acidic and alkaline water as end products. In addition, flow-through devices tend to build up scale on the electrodes, thereby decreasing the efficiency of electrolysis. With existing batch treatment systems, scaling can also be a problem.

Another method of treating water to impart properties to it which are beneficial to health is to expose the water to a magnetic field. Exposure to a magnetic field affects the structure of the water molecules, which can be observed with nuclear magnetic resonance studies (NMR). See U.S. Pat. No. 5,584,994 (Hattori et al.). The effect of a magnetic field on water molecules can last for a prolonged period of time.

More recently, the effect of vortex flow on the molecular structure of water has been studied and has also been found to impart health benefits. Vortex energy has also been linked with magnetic energy, and their effects have been found to be complementary to each other in altering the nuclear resonance and molecular structure of water.

It would be desirable to combine the steps of electrolyzing, magnetizing, and re-resonating water to produce combined and/or prolonged effects on the water.

### SUMMARY OF INVENTION

The present invention provides a water treatment device for electrolyzing, magnetizing, and re-resonating water in a convenient-to-use batch treatment system. The water treatment device comprises an electrolytic chamber which is divided by a semi-permeable micropore membrane to form a cathode chamber and an anode chamber. The membrane, which can be disposable, allows electrons and solutes to flow between the cathode chamber and anode chamber. Each anode chamber and cathode chamber contains an electrode. The cathode chamber has a vortex electrode which has been wound into a vortex pattern, using a naturally occurring spiral, such as the spiral of a seashell, as a template. The cathode chamber also contains an insulated wire coil, positioned immediately above the tip of the vortex electrode, which acts as an electromagnet when current is applied to the device. The water treatment device can operate on DC current from a power supply. A timer can be used to control the duration of electrolysis, magnetization, and re-resonance for each batch of water. The water treatment device is relatively small and can be more convenient to use than flow-through water electrolysis devices. The effect of the water treatment device can last for prolonged periods.

The invention also discloses a method for producing electrolyzed, magnetized, and re-resonated water with the water treatment device. First, the electrolytic chamber is filled with a dilute salt solution. The device can be activated by selecting a suitable length of time on a timer to run electric current through the device. Usually the reaction is complete within a few minutes. When the device is activated, oxygen gas and a weak acidic solution are formed in the anode chamber. In the cathode chamber, hydrogen gas is formed at the vortex electrode along with a weak alkaline solution, and both products are exposed to the electromagnet. Electric current stops running through the device when the timer stops. The treated water can then be dispensed from the device and used.

The treated water in the cathode chamber, which is electrolyzed, magnetized, and re-resonated water, can be consumed.

The treated water in the anode chamber, because it is acidic, can be used for cleaning or as a skin conditioner.

### BRIEF DESCRIPTION OF DRAWINGS

FIG. 1 is a schematic diagram of the water treatment device.

FIG. 2A is a front perspective view of an embodiment of the water treatment device.

FIG. 2B is a side plan view of the embodiment of FIG. 2A.

FIG. 2C is perspective view of an alternative embodiment of the water treatment device.

FIG. 2D is a perspective view of a cover for the alternative embodiment of FIG. 2C.

FIG. 3 depicts T2 decay curves for an untreated mineral water sample and an electrolyzed, magnetized, re-resonated water sample treated with the water treatment device.

FIG. 4 depicts T2 decay curves for an untreated mineral water sample and an electrolyzed, magnetized, re-resonated water sample treated with the water treatment device.

FIG. 5 depicts T2 decay curves for an untreated tap water sample and an electrolyzed, magnetized, re-resonated water sample treated with the water treatment device measured 10 minutes after treatment.

FIG. 6 depicts T2 decay curves for an untreated tap water sample and an electrolyzed, magnetized, re-resonated water sample treated with the water treatment device measured one hour after treatment.

FIG. 7 is an NMR spectrum of an untreated water sample.

FIG. 8 is an NMR spectrum of a water sample electrolyzed with standard plate electrodes.

FIG. 9 is an NMR spectrum of a water sample treated with the electrolyzing, magnetizing, and re-resonating water treatment device.

### DETAILED DESCRIPTION OF THE PREFERRED EMBODIMENTS OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

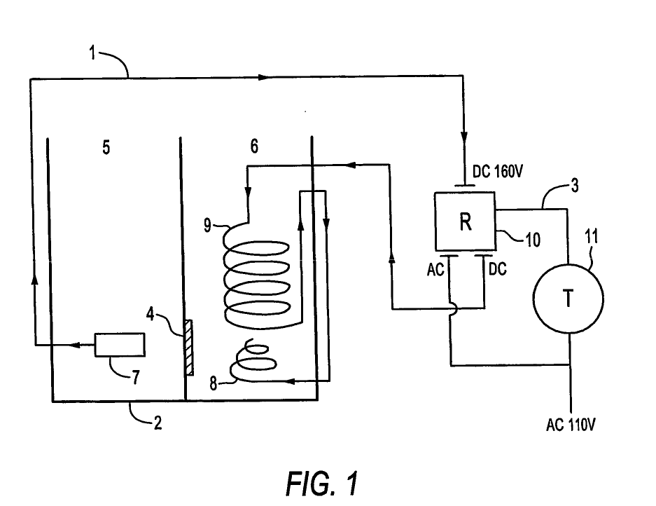

With reference to FIG. 1, the invention comprises a water treatment device 1 comprising an electrolytic chamber 2 and a power source 3. The electrolytic chamber is separated by a micropore membrane 4 into a cathode chamber 5 and an anode chamber 6. The membrane comprises semi-permeable material and it can be disposable. “Semi-permeable” in this specification means that the membrane allows electrons and ions to pass through but prevents the passage of larger molecules, preventing scale buildup on the electrodes. The anode chamber has an anode 7. The cathode chamber has a cathode 8 that has been wound into a vortex shape, using a naturally occurring spiral, such as a spiral seashell, as a template. It is preferably oriented about a generally upright center axis. A coiled electromagnet 9 is positioned directly above the coiled cathode, the electromagnet preferably having a generally upright longitudinal axis that is generally aligned with the center axis of the vortex electrode. The electromagnet can be made from a coil of metal wire which is insulated to prevent corrosion. Electric current flows from the power source to the electromagnet and the electrodes. Electric current flows through the electromagnet in such a manner that the north pole of the magnet is positioned downwards, directly over the vortex cathode, and is proximate to the cathode. Alternatively, a permanent magnet can be installed in place of the electromagnet, with the north pole pointing downward, proximate to the vortex cathode. The power source includes a rectifier 10 to convert AC current to DC current. A timer 11 can be installed on the power source to activate and de-activate the power source for measured time intervals.

To produce electrolyzed, magnetized, and re-resonated water, the electrolytic chamber 2 is filled with an electrolytic solution, such as 0.1% NaCl or 0.1% KCl or any other suitable salt solution. The timer 11 is activated for a selected period of time, which in turn can activate the water treatment device by allowing current to flow through the device. While the device is in operation, the electrolytic solution is electrolyzed such that oxygen gas is produced at the anode along with acidic water, and hydrogen gas is produced at the cathode along with alkaline water. In the cathode chamber, the alkaline water is magnetized by the electromagnet and exposed to the vortex action of the cathode. Once the selected period of time has elapsed on the timer, the water treatment device is deactivated. Alternatively, the water treatment device can be activated and deactivated manually. Once the water has been treated, the anode chamber then contains acidic water, and the cathode chamber contains alkaline, magnetized, re-resonated water which can be dispensed. The acidic water can be used for cleaning or as a skin conditioner. The alkaline, magnetized, re-resonated water is used for consumption.

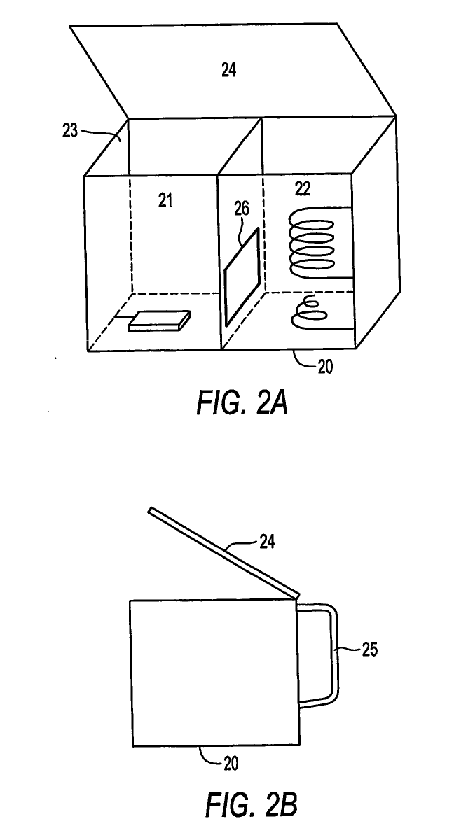

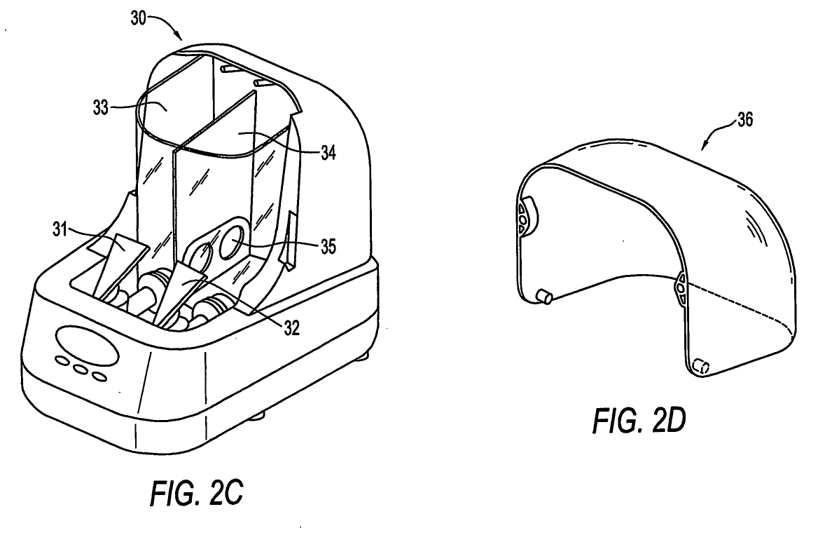

In one embodiment, as shown in FIGS. 2A and 2B, the water treatment device 20 can be constructed so that at least one side of each of the cathode chamber 21 and anode chamber 22 comprises a transparent material, such as plastic or glass, to allow users to observe the oxygen and hydrogen gas bubbles forming in the chambers and thereby determine whether the device is in operation. The micropore membrane 26 can be made from polysulphone, a semi-permeable material available from Osmotics, Inc. with a pore size of approximately 0.8 microns, which prevents scale buildup. The cathode and anode chambers have openings 23 on the top which allow them to be filled with an electrolytic solution. A lid 24 can be placed over the openings. The water treatment device can have a handle or handles 25 on the outside. The device is made of a size suitable to process convenient volumes of electrolytic solutions, such as 500 mL, 1 litre, 2 litres or even larger volumes. The anode can comprise platinum or any other suitable material. The vortex cathode can comprise stainless steel or any other suitable material. The electromagnet preferably comprises an insulated coil of copper wire, although other materials would also be suitable for use as a wire. The electromagnet can also comprise a permanent magnet.

In an alternative embodiment, as shown in FIG. 2C, the water treatment device can comprise a countertop unit 30 for dispensing electrolyzed, magnetized, and re-resonated water. The device 30 comprises a cathode spigot 31 for dispensing acidic water from the cathode chamber 33 and an anode spigot 32 for dispensing electrolyzed, magnetized, and re-resonated water from the anode chamber 34. The cathode chamber and anode chamber are separated by a micropore membrane 35. The anode chamber also comprises a vortex anode and an electromagnet, which are not illustrated so that other features of the embodiment are not obstructed. As shown in FIG. 2C, the front of the cathode and anode chambers can comprise transparent material to allow users to view the cathode and anode chambers. The countertop water treatment device 30 also comprises a cover 36 as shown in FIG. 2D.

Effect of Vortex Cathode on Efficiency of Water Treatment

Two different batch electrolysis water treatment devices were tested for their ability to electrolyze water. One device contained standard plate electrodes. The other device tested was the electrolyzing, magnetizing, re-resonating water treatment device of the invention which contains a vortex cathode and electromagnet in the cathode chamber, as described above. Thirty samples were tested with each of the water treatment devices, and measurements of pH, redox potential, and resistivity of the samples were taken. All reactions were conducted for 3 minutes, using a 0.1% sea salt electrolytic solution. The pH, redox potential (rH2), and resistivity (R) of the water samples were measured after electrolysis using a B.E.V. machine, manufactured by Medtronic. The results were averaged and are summarized in Table 1.

TABLE 1
Characteristics of water samples treated with two different
types of electrolysis devices.

| Electrode Type | pH | rH2 | R |
|---|---|---|---|
| Plate Cathode | 10.60 | 20.84 | 210 |
| Vortex Cathode | 10.77 | 12.31 | 343 |

As shown in Table 1, the water treatment device of the invention, with a vortex cathode, produced water with higher pH, higher redox potential (as indicated by a lower rH2 value), and higher resistivity (R values) than the prior art water treatment device containing only a standard plate cathode. Therefore, the electrolytic water treatment device of the invention, which contains a vortex cathode and electromagnet, treated the water more effectively than the electrolytic water treatment device with standard prior art plate electrodes.

Effect of Electrolyzing, Magnetizing, and Re-Resonating Water

The nuclear magnetic resonance parameter T2 of three different water samples was measured and compared. T2 is a coherence time constant for the proton magnetic resonance from water. It is related to the width of the proton line in the spectrum from water. The first water sample measured was mineral water. The second water sample measured was tap water. The third water sample measured was electrolyzed, magnetized and re-resonated water treated in the water treatment device of the invention.

For each sample, T2 was measured using a multi echo decay curve with samples of signal at 48 times from 10 ms to 320 ms in steps of 10 ms and from 370 ms to 1.120 s in steps of 50 ms. These measurements were done on a 1.5 T General Electric MRI scanner. Tables 2 to 5 contain a summary of the results.

TABLE 2
T2 measurement of electrolyzed, magnetized, and re-
resonated water and untreated mineral water immediately
after energization.

| Sample | TE (s) | Signal | T2 (s) |
|---|---|---|---|
| Mineral water | 0.01 | 2057 | 1.97 |
| | 0.1 | 1945 | |
| | 0.32 | 1732 | |
| | 0.72 | 1424 | |
| | 1.12 | 1165 | |
| Electrolyzed, magnetized, | 0.01 | 2011 | 2.73 |
| re-resonated water | 0.1 | 1931 | |
| | 0.32 | 1772 | |
| | 0.72 | 1540 | |
| | 1.12 | 1335 | |

TABLE 3
T2 measurements of electrolyzed, magnetized, and re-
resonated water and untreated mineral water immediately
after energization.

| Sample | TE (s) | Signal | T2 (s) |
|---|---|---|---|
| Mineral water | 0.01 | 2055 | 2.06 |
| | 0.1 | 1953 | |
| | 0.32 | 1743 | |
| | 0.72 | 1499 | |
| | 1.12 | 1176 | |
| Electrolyzed, magnetized, | 0.01 | 2065 | 2.68 |
| re-resonated water | 0.1 | 1981 | |
| | 0.32 | 1824 | |
| | 0.72 | 1584 | |
| | 1.12 | 1356 | |

TABLE 4
T2 measurement of electrolyzed, magnetized, and re-
resonated water and untreated tap water 10 minutes after
energization.

| Sample | TE (s) | Signal | T2 (s) |
|---|---|---|---|
| Tap water | 0.01 | 2297 | 1.67 |
| | 0.1 | 2156 | |
| | 0.32 | 1877 | |
| | 0.72 | 1487 | |
| | 1.12 | 1178 | |
| Electrolyzed, magnetized, | 0.01 | 2076 | 1.75 |
| re-resonated water | 0.1 | 1992 | |
| | 0.32 | 1834 | |
| | 0.72 | 1593 | |
| | 1.12 | 1381 | |

TABLE 5
T2 measurements of electrolyzed, magnetized, and re-
resonated water and untreated tap water 1 hour after
energization.

| Sample | TE (s) | Signal | T2 (s) |
|---|---|---|---|
| Tap water | 0.01 | 2218 | 1.68 |
| | 0.1 | 2084 | |
| | 0.32 | 1813 | |
| | 0.72 | 1440 | |
| | 1.12 | 1141 | |
| Electrolyzed, magnetized, | 0.01 | 2083 | 2.67 |
| re-resonated water | 0.1 | 1994 | |
| | 0.32 | 1837 | |
| | 0.72 | 1587 | |
| | 1.12 | 1367 | |

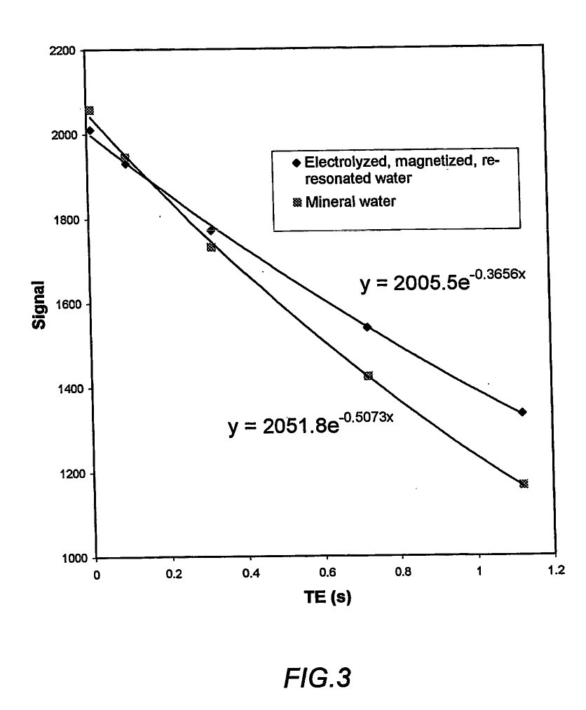

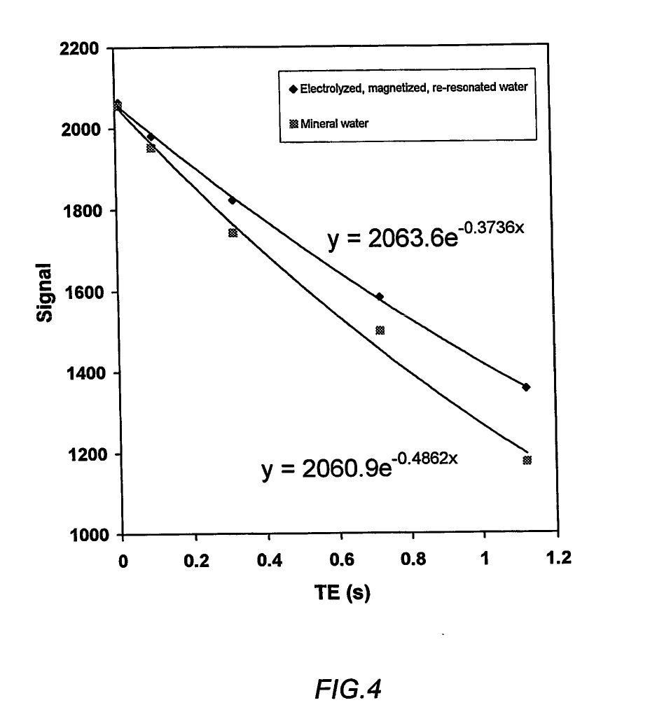

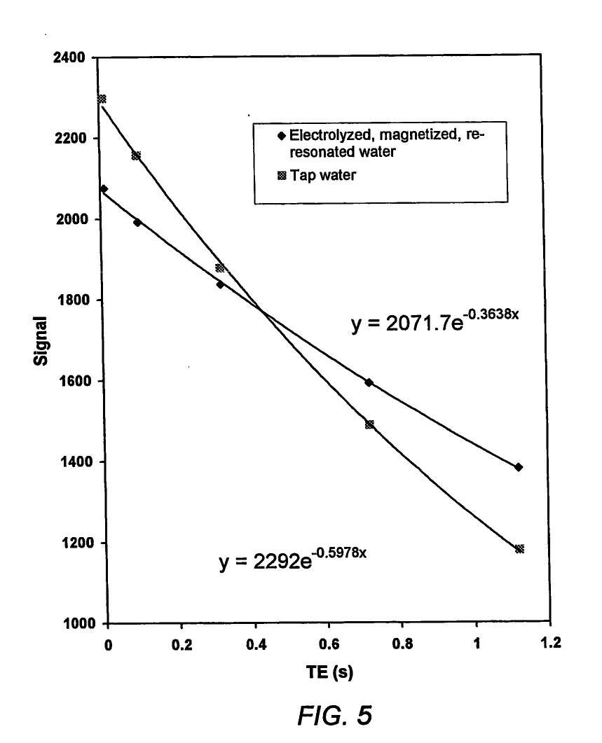

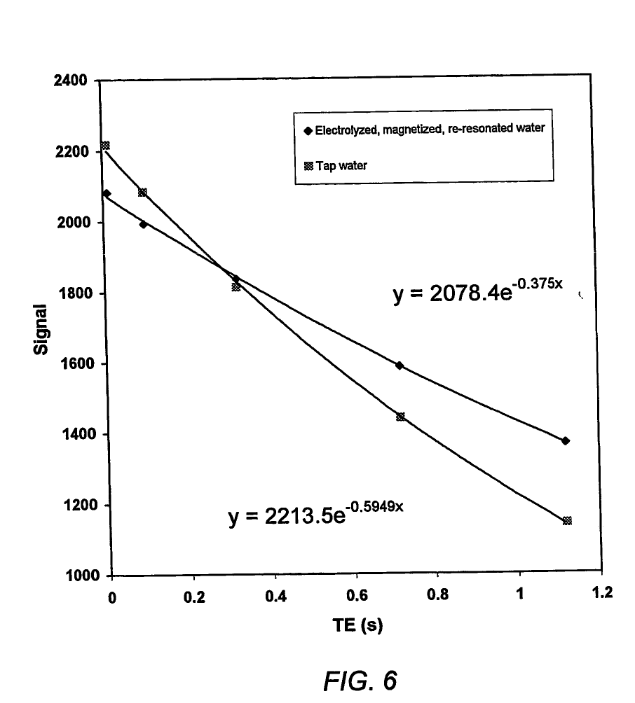

Data from Tables 2 to 5 were plotted as nuclear magnetic resonance (NMR) signal vs. time (T2 decay curves), as shown in FIGS. 3 to 6 respectively. The signal follows S(t)=S(0)exp(−TE/T2), so a logarithmetic plot of signal vs. time has slope −1/T2. Therefore, a steeper slope illustrates a shorter T2 time.

As seen in each of FIGS. 3 to 6, the slope of the T2 decay curve of the untreated tap water or untreated mineral water is steeper than the T2 decay curve of the electrolyzed, magnetized, and re-resonated water. This illustrates that the electrolyzed, magnetized, and re-resonated water has a longer T2 value than the untreated water. Generally, a longer T2 time indicates less solutes or less impurities. Even after 1 hour, the electrolyzed, magnetized, and re-resonated water maintained its T2 value.

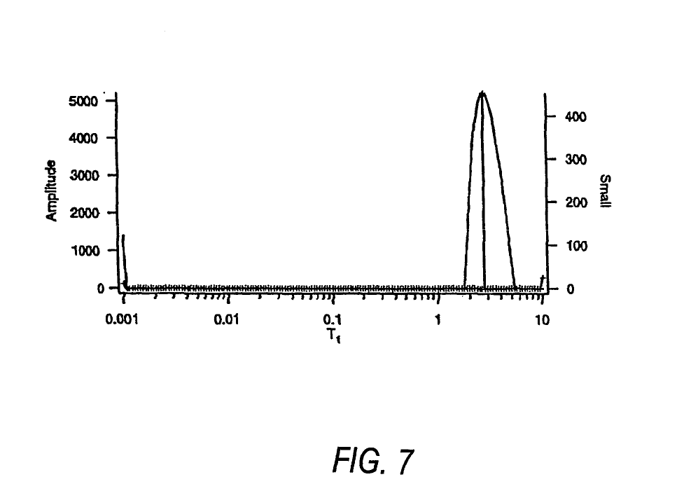

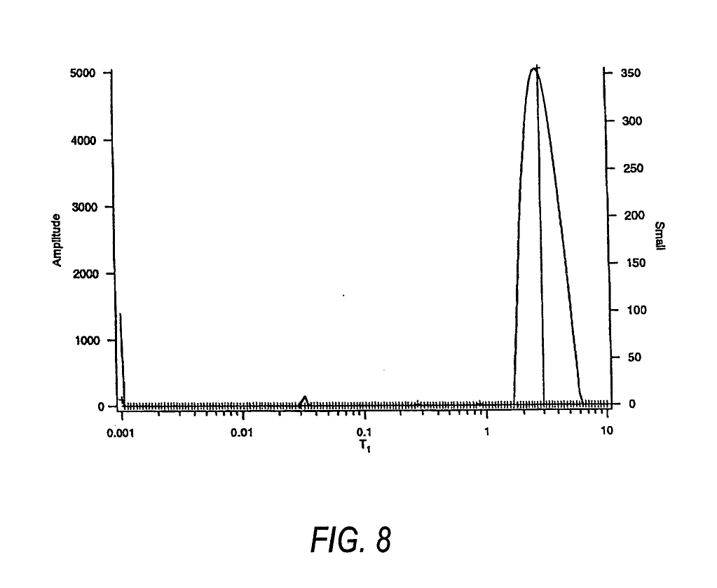

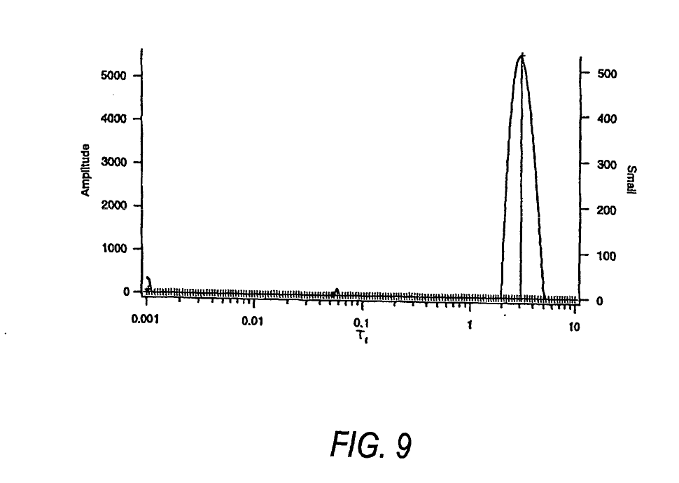

The effect of different water treatment devices was also tested. Three samples of electrolytic solution were tested, each sample comprising 0.1% sea salt, made by adding 1 gram of sea salt to 1 litre of distilled water. The first sample was not electrolyzed and T2 was measured. FIG. 7 is the NMR spectrum for Sample 1. The second sample was electrolyzed for 3 minutes using an electrolysis device containing standard plate cathodes and anodes, and then T2 was measured. The NMR spectrum for Sample 2 is shown in FIG. 8. The third sample was electrolyzed for 3 minutes using the electrolyzing, magnetizing, and re-resonating water treatment device described herein containing a vortex cathode and electromagnet in the cathode chamber, and then T2 was measured. The NMR spectrum for Sample 3 is shown in FIG. 9. Sample 3 produced a longer T2 than either Sample 2 or Sample 1. The results of the scans are summarized in Table 6.

TABLE 6
Summary of NMR Spectra Data of Treated and Untreated
Water Samples.

| | | Peak Signal |
|---|---|---|
| Sample | T₂ (s) | (LS-Small) |
| 1) Untreated Water, no electrolysis | 2.796 | 454.57 |
| 2) Plate Electrolysis | 2.796 | 355.79 |
| 3) Vortex and Electromagnet | 2.962 | 535.09 |
| Electrolysis | | |

As will be apparent to those skilled in the art, in the light of the foregoing disclosure, many alterations and modifications are possible in the practice of this invention without departing from the spirit or scope thereof. Accordingly, the scope of the invention is to be construed in accordance with the substance defined by the following features of the invention.

1. A water treatment device for electrolyzing, magnetizing, and re-resonating water comprising:
a) an anode chamber;
b) a cathode chamber;
c) a semi-permeable membrane separating the anode chamber from the cathode chamber;
d) an anode within the anode chamber;
e) a vortex cathode within the cathode chamber;
f) a magnet inside the cathode chamber; and
g) a power source to supply electric current to the water treatment device.

2. The water treatment device as claimed in claim 1 wherein the vortex cathode comprises wire wound into a vortex pattern using a natural template.

3. The water treatment device as claimed in claim 2 wherein the natural template comprises a seashell spiral.

4. The water treatment device as claimed in claim 1 wherein the vortex cathode has a generally upright center axis.

5. The water treatment device as claimed in claim 1, wherein the north pole of the magnet is positioned over and is proximate to the vortex cathode.

6. The water treatment device as claimed in claim 1, wherein the magnet comprises an electromagnet.

7. The water treatment device as claimed in claim 1, wherein the magnet comprises a permanent magnet.

8. The water treatment device as claimed in claim 1. wherein the semi-permeable membrane has pores approximately 0.8 microns in diameter.

9. The water treatment device as claimed in claim 8 wherein the semi-permeable membrane comprises polysulphone.

10. The water treatment device as claimed in claim 1, wherein the water treatment device further comprises a rectifier.

11. The water treatment device as claimed in claim 1, wherein the water treatment device further comprises a timer.

12. The water treatment device as claimed in claim 1, wherein the wherein the water treatment device comprises a counter top dispensing unit.

13. A method of producing electrolyzed, magnetized, and re-resonated water, comprising the steps of:
a) providing an electrolytic chamber comprising:
i) an anode chamber having an anode;
ii) a cathode chamber having a vortex cathode and a magnet; and
iii) a semi-permeable membrane separating the anode chamber from the cathode chamber;
b) filling said electrolytic chamber with an electrolytic solution;
c) passing an electric current through said device to electrolyze said electrolytic solution to produce oxygen gas at said anode and hydrogen gas at said cathode;
d) exposing said electrolytic solution and hydrogen gas in said cathode chamber to a magnetic field generated by a magnet in said cathode chamber;
e) re-resonating said electrolytic solution by exposing it to the vortex cathode; and
f) deactivating the water treatment device.

14. The method according to claim 13, wherein the magnetic field is generated by a coil-shaped electromagnet positioned over and proximate to said vortex cathode.

15. The method according to claim 13, wherein the magnetic field is generated by a permanent magnet positioned over and proximate to said vortex cathode.

16. The method according to claim 13, wherein the north pole of the magnetic field is positioned over and proximate to said vortex cathode.

17. The method according to claim 13, wherein the water treatment device is activated and deactivated by a timer.

18. The method according to claim 13, wherein the electrolytic solution comprises 0.1% NaCl or 0.1% KCl.
